(19) United States
(12) Patent Application Publication
(10) Pub. No.: US 2006/0206383 A1
(43) Pub. Date: Sep. 14, 2006

(54) Method for advertising and selling products online

(76) Inventors: Adam Matthew Litt, Jacksonville, FL (US); Garrod Litt, Jacksonville, FL (US); Andrew Frederick Knight, Canon, GA (US)

Correspondence Address: NAKED WEIGHTLIFTING, 2560 LAUREL OAK DRIVE, HOWELL, MI, 48855, US

(21) Appl. No.: 11/418,662

(22) Filed: May 6, 2006

Related U.S. Application Data
(63) Continuation-in-part of application No. 10/712,380, filed on Nov. 14, 2003.

(51) Int. Cl. G06Q 30/00

(52) U.S. Cl. 705/14

(57) ABSTRACT

A method of advertising includes creating and providing a customer with an electronic address, assigning the electronic address to an internet web page so that the internet web page is viewable when the electronic address is accessed, encouraging the customer to advertise the electronic address in a non-internet medium, and enabling the customer to automatically advertise the electronic address in a non-internet medium by submitting an advertisement containing the electronic address to the non-internet medium on behalf of the customer. The electronic address includes a primary address and a secondary address, the primary address assigned to a main web page and the secondary address having at least one of the following properties: the secondary address is chosen at least in part by the customer; and the secondary address contains no more than approximately fifteen characters.

### REFERENCE TO RELATED APPLICATIONS

The present application is a Continuation-in-Part (CIP) of U.S. patent application Ser. No. 10/712,380, entitled “Method for Advertising and Selling Products Online,” filed Nov. 14, 2003, the disclosure of which is hereby incorporated by reference.

### BACKGROUND

Presently, when a person wants to sell a product, she may choose one of several options. A first option is to list the product on any one of several well-known web-based online bidding sites, such as www.eBay.com. A second option is to advertise the product in a classified advertisement in a local newspaper. A third option is to advertise the product in photo-based classified advertisement publication that is specifically designed for providing pictured advertisements. A fourth option is to print flyers and post the flyers in conspicuous locations, such as at the seller's office, in the seller's apartment or housing complex or community, at the seller's school, etc. A fifth option is to tell her friends, family, and co-workers about the product, such as via email. There are several other options available to the seller, as known by those skilled in the art.

### SUMMARY OF THE INVENTION

There are many problems with the above options. A problem with the first option (e.g., eBay) is that the potential buyer base is limited to those who are already regular eBay users. Those who read newspaper classified ads only, for example, will not learn about the product for sale online. A problem with the second option is twofold. First, to properly describe an item, a classified ad may have to be very long; because classified ads are usually priced by length, such an option may be relatively expensive. Second, many products are not amenable to advertisement with words only (i.e., they need a picture), such as furniture, cars, boats, clothing, antiques, pets, homes, and so forth. A problem with the third option, which partially solves the problems of the second option by providing a photograph, is also twofold. First, the price of advertising is often relatively high, and often there is a price for the publication that may deter potential buyers from reading the publication. Second, such publications are usually limited only to advertisements for cars for sale. A problem with the fourth and fifth options is that it is usually used in conjunction with one or more of the first three options, and so it requires the seller repeating the work of providing and formatting the information about the item for sale. The present invention aims to solve one or more of these and other problems.

In a preferred embodiment of the present invention, a method for advertising and selling products online may comprise: a) providing to a customer an item information template for inputting information into an electronic information database; b) prompting said customer via said template to enter item information into said database about at least one item for sale by said customer; c) creating an electronic web page associated with one of said customer and said item; d) displaying said item information on said web page; e) creating and providing said customer with an electronic address; and f) assigning said electronic address to said web page so that said item information displayed on said web page is viewable when said electronic address is accessed, wherein said electronic address has a primary address and a secondary address, said primary address assigned to a main web page and said secondary address having at least one of the following properties: said secondary address is chosen at least in part by said customer, and said secondary address contains no more than fifteen characters. The item information may include one of a digital photograph and a digital video of said item for sale. The primary address may include a designation of a geographical region, wherein said geographical region includes one of a city and a state.

In a preferred aspect, the method may further comprise encouraging said customer to advertise said electronic address in a non-electronic medium, such as a flyer, a newspaper advertisement, a magazine advertisement, or a classified advertisement in a newspaper.

In another preferred aspect, the method may further comprise advertising said electronic address in a non-electronic medium. The method may further comprise querying said customer as to whether said customer desires to submit a classified advertisement to a newspaper and, if so, automatically submitting a classified advertisement request to said newspaper on behalf of said customer.

In another preferred aspect, said secondary address may be chosen at least in part by said customer and approved by said customer. In another preferred aspect, said secondary address may contain no more than 10 characters.

In another preferred aspect, the method may further comprise providing said customer with an option, such as a one-click option, of creating a flyer based on said item information, wherein if said customer chooses said option, said item information is automatically formatted for a flyer, a flyer is automatically created, and said customer is enabled to print said flyer.

In another preferred aspect, the web page may be associated with said customer, wherein said displaying said item information on said web page comprises displaying only said item information on said web page. Alternatively, said web page may be associated with said item, wherein said item information is about exactly one item for sale by said customer.

In another preferred aspect, the method may further comprise charging said customer a price for performing steps a)-f), further comprising providing to said customer a comparison of: an estimated cost of running a long classified advertisement in a local newspaper containing information comparable to said item information; and a sum of said price and an estimated cost of running a short classified advertisement in said local newspaper containing said electronic address and substantially less information than said item information.

In another preferred aspect, said web page may be associated with said main web page, further comprising providing a search engine configured to allow customers to search a plurality of web pages associated with said main web page based on at least one of the following: location of an item for sale; type of item for sale; and price of an item for sale.

In another preferred aspect, the method may further comprise: providing to a different customer a wanted item information template for inputting information into said database; prompting said different customer via said wanted item information template to enter wanted item information into said database about at least one item wanted for purchase by said different customer; and if said item information matches said wanted item information, notifying said different customer about said item information. The method may further comprise querying said different customer as to whether said different customer desires to submit a classified advertisement to a newspaper regarding said wanted item information and, if so, automatically submitting a classified advertisement request to said newspaper on behalf of said different customer, said classified advertisement containing at least said primary address.

In another preferred aspect, the method may further comprise prompting said customer to enter e-mail contact information of potential buyers into said database.

In another preferred aspect, the method may further comprise prompting potential purchasers of said at least one item for sale to submit bid information, and at least one of: displaying said bid information with said item information on said web page; and notifying said customer of said bid information.

### BRIEF DESCRIPTION OF THE DRAWINGS

FIG. 1 shows a first screen view of a preferred embodiment of the present invention.

FIG. 2 shows a second screen view of a preferred embodiment of the present invention.

FIG. 3 shows a third screen view of a preferred embodiment of the present invention.

FIG. 4 shows a fourth screen view of a preferred embodiment of the present invention.

FIG. 5 shows a fifth screen view of a preferred embodiment of the present invention.

FIG. 6 shows a sixth screen view of a preferred embodiment of the present invention.

FIG. 7 shows a seventh screen view of a preferred embodiment of the present invention.

FIG. 8 shows another screen view of a preferred embodiment of the present invention.

### DETAILED DESCRIPTION OF PREFERRED EMBODIMENTS

The present invention aims to solve the mentioned problems with a general method. The method will be described with respect to one possible embodiment. One skilled in the art will recognize that a great many possible embodiments of the present invention exist.

In one embodiment, the present invention includes a method of advertising and selling products online. A seller may obtain his own web page through the company's main website, may upload product information to that web page, and may directly advertise that web page in typical non-electronic media, such as a newspaper classified ad.

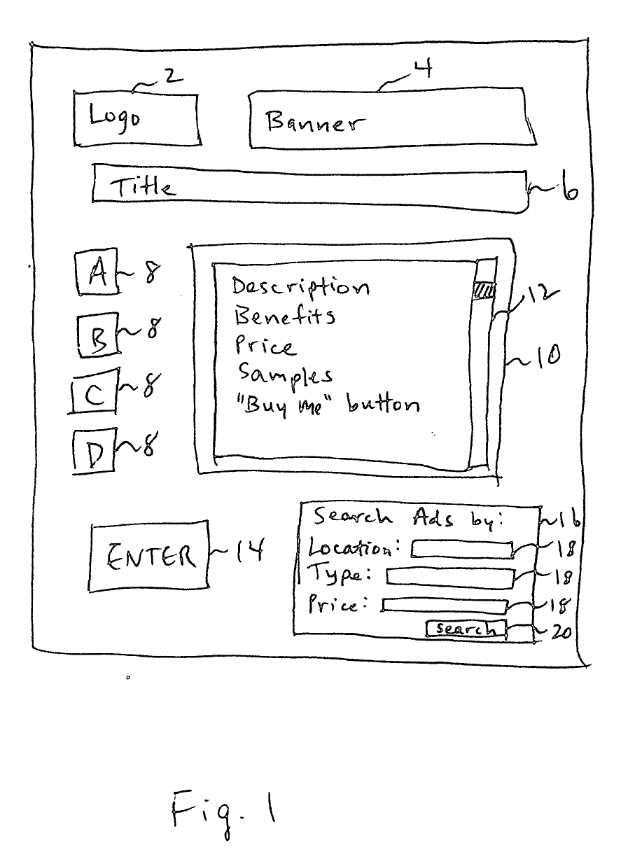

Referring now to FIG. 1, a main web page of a preferred embodiment of the present invention may include a logo 2, a banner 4, a title region 6, package designation buttons 8, window 10 with scroll bar 12, an “enter” button 14, and a search engine interface 16 including data entry fields 18 and a “search” button 20. The main web page is stored in the form of executable computer code on an information database, such as a server or hard drive, and may be downloadable from a server connected to the World Wide Web (www). Further, the internet protocol (IP) address of the www-accessible web page may be linked to a simpler or more readable address, such as xyz.com, and may be downloadable from the server by typing www.xyz.com or http://www.xyz.com, or the like, as known to one skilled in the art, in the address box of a typical web browser having access to www. A typical web browser may include Microsoft Internet Explorer or Netscape Navigator. As known in the art, some or all of the buttons, windows, or displays may include a user interface feature. For example, buttons 8 may include a link to a different web page, so that when the user clicks on the button, the different web page appears on the screen of the web browser. Further, data entry fields 18 are fields into which the user may enter information. The data entry fields 18 could, of course, comprise drop-down menus, in which the user selects the desired entry based on a list or menu of possible options. As well known to one skilled in the art, the web pages or screen views shown in the figures may be created by executing typical computer code, such as HTML or XML.

The web address for the main web page, such as www.xyz.com, may be associated with a company doing business. The logo 2 may be an image of the company's logo. Banner 4 may be an advertisement, either for a different (preferably nonrelated) company's website or for a website of a partner or subsidiary of the same company, and the banner 4 may include a link to the address of the advertised website. Alternatively, the banner 4 may be an advertisement for an internal webpage of a user of the company's website—i.e., the banner 4 may link to one of the primary/secondary web addresses of the company's website, as will be discussed later. The title region 6 may simply contain an image of the title of the company, or a title of the website.

The main web page of the company's website may be accessible by a single primary web address, such as www.xyz.com, or the company may have several main web pages each accessible by a distinct primary web address, each primary web address associated with a particular geographical location, such as a city or state. For example, miami.xyz.com may be the primary web address associated with a main web page of the company's website, in which only products located in Miami are located or searchable by potential buyers. As another example, assume a potential purchase is looking to purchase a car in Rhode Island. Instead of viewing the web pages associated with the primary web address www.xyz.com (which may include ads for cars located throughout the country), the potential purchaser may instead access the Rhode-Island-specific main web page at ri.xyz.com (or the like), which may include ads for products located only on Rhode Island. For simplicity, the names of cities may be abbreviated as three letters, so that, for example, the primary web address associated with the Miami version or webpage of the company's website may be mia.xyz.com. Alternatively, the primary address for a city may be written in a slightly different way, such as www.xyz.com/orl for the Orlando website and www.xyz.com/nyc for the New York City website.

In one embodiment of the present invention, the consumer is offered several different products, each having its own features, benefits, and price. For example, there may be four package designation buttons 8, each one designating one of packages A, B, C, and D. The buttons 8, as discussed, preferably contain a link to a web page corresponding to the package chosen, such as a sample picture of a web page created according to the method described herein. Alternatively, a description of one or more of the packages (e.g., description, benefits, price, and samples) may appear in a window 10 which may have a scroll bar 12 if there is too much information to fit in the window 10. The window 10 may contain information about all four packages, or the content of the window 10 may change depending on which package designation button 8 is clicked on with the mouse. An enter button 14 may have a link to a more descriptive web page, such as a page describing each of the packages, or the benefits of the product as a whole. Further, the main page shown in FIG. 1 may also have a search engine interface 16 in which consumers may search for ads hosted within the site, as will be discussed later. Consumers may search ads by many different criteria, among which may include location (such as all products physically located in Denver, Colo.), type (such as all automobiles or all dogs), and price (such as less than $500, or between $1000 and $2000). The interface 16 may also include a search button 20, which the consumer may click with the mouse after entering the search information in the data entry fields 18. Clicking the button may send the search information to a processor (not shown) which then may filter, sort, and/or prioritize ads based on the search information.

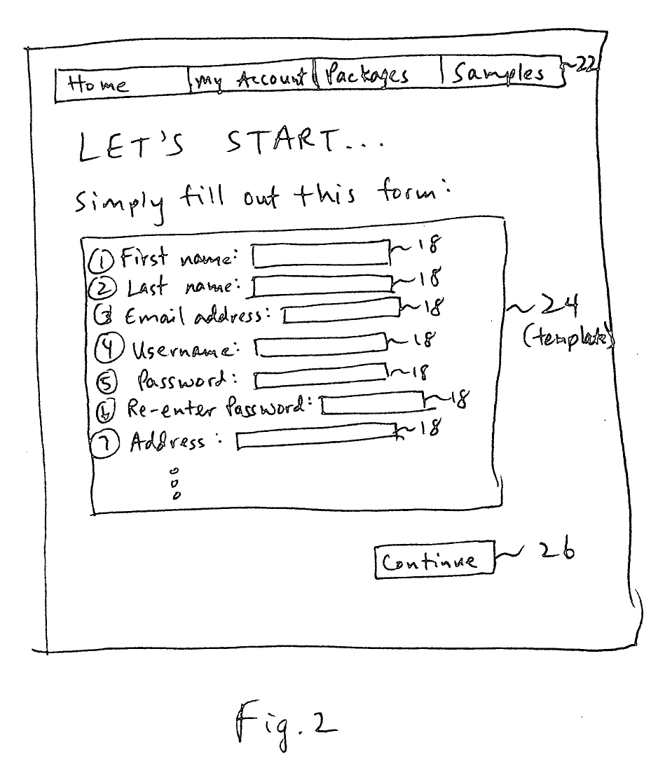

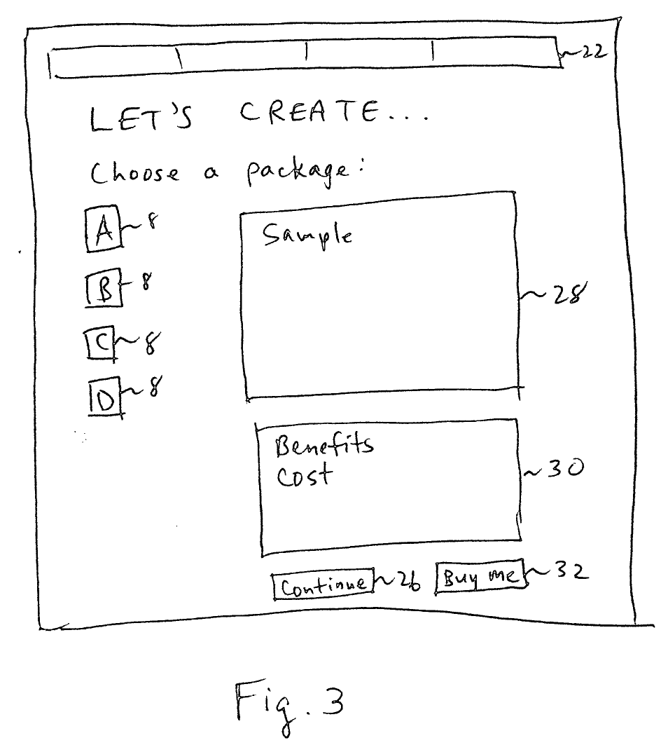

FIG. 2 shows a second web page of a preferred embodiment. The web page in FIG. 2 may be accessed, for example, by clicking on the enter button 14 shown in FIG. 1. The web page shown in FIG. 2 is a first of possibly several templates to allow the consumer to enter personal information as well as information about the product for sale by the consumer. Option menu 22 may contain one or more links to other web pages within the site, such as a “home” or main page (e.g., as shown in FIG. 1), a “my account” page (not shown) which may allow the consumer to enter, delete, or edit personal or item information, a “packages” page (e.g., as shown in FIG. 3) which may demonstrate or explain the different packages A, B, C, D available for purchase, and a “samples” page (e.g., sample screen 28 in FIG. 3) which may demonstrate one or more samples of web pages showing items for sale. The option menu 22 may be standard on some or all of the web site's pages, and may include other links, as understood by one skilled in the art. The web page shown in FIG. 2 includes a template 24 in which the consumer may enter personal and/or contact information via data entry fields 18, such as name, email address, a consumer-chosen username and password, physical address, etc. The page may include a continue button 26 that the consumer may click after entering all the relevant information into template 24. Clicking the continue button 26 may upload the information entered in the data entry fields 18 to a hard drive or web server accessible by the company associated with the website (hereinafter “the company's server”).

FIG. 3 shows a continuation of the template introduced in FIG. 2. In the web page shown in FIG. 3, the consumer is prompted to choose at least one of the available packages A, B, C, D by clicking on one of the appropriate buttons 8. The web page may include a sample screen 28 for demonstrating a sample version of a web page showing an item for sale, the web page being a product of the clicked package button 8. In other words, clicking the “A” button 8 will cause a sample web page, formatted according to the features of package A, to appear in the sample screen 28 for viewing by the consumer. Further, also according to the selection of the package buttons 8, a description screen 30 may provide text or other description of the selected package A, B, C, D, such as costs, benefits, and features. The web page shown in FIG. 3 may include a “buy me” button 32, allowing the consumer to, select for purchase the chosen package A, B, C, D.

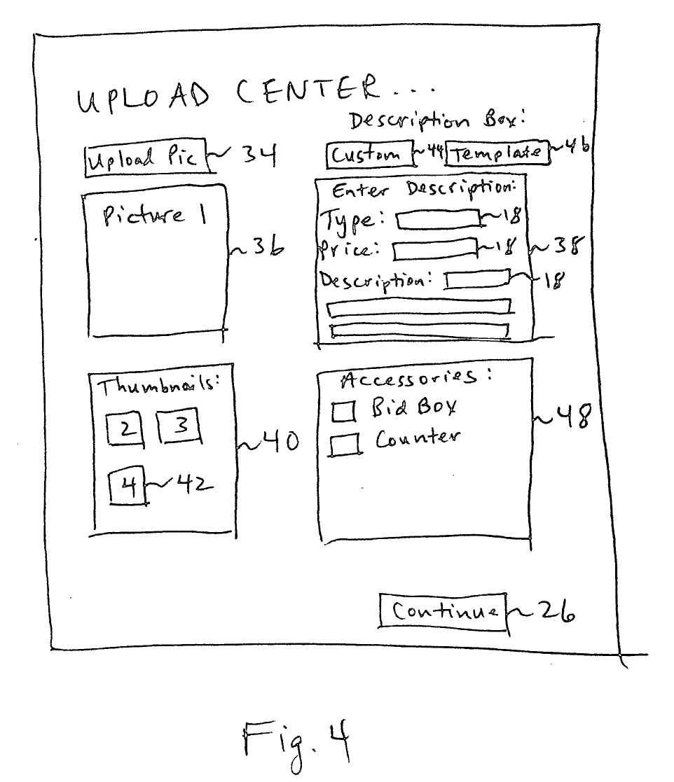

FIG. 4 shows a continuation of the template introduced in FIG. 2. In the web page shown in FIG. 3, the consumer is prompted to upload information about the product(s) for sale by the consumer. For example, the web page may include an “upload picture” button 34, a picture display 36, a description entrance template 38, a selection between a custom description entrance 44 or a template-based description entrance 46, a thumbnail selection screen 40, and an accessories selection screen 48. The consumer may upload a first picture of the product for sale by clicking the “upload picture” button 34 or by clicking on a thumbnail 42. (Alternatively, the first or any picture may instead be a video that may include sound.) As understood in the art, the consumer may then be prompted to locate the file on his hard drive or network and to transfer the file to the company's server. The consumer may also upload several other pictures, and the previously uploaded pictures may appear as very small pictures or “thumbnails” in the thumbnail selection screen 40. The other pictures may be pictures of the same product (such as from different angles), or may be of entirely different products. After uploading all relevant pictures of the item for sale (or between uploading different pictures), the consumer may enter information about the product shown in the picture display 36 via the description entrance template 38. For example, if the consumer wants to enter information about the second picture uploaded, she may click on the corresponding thumbnail in the thumbnail selection screen 40. This may cause the selected picture to be displayed in the picture display 36, and may enable the consumer to enter information about the product shown in the picture display via the description entrance template 38. In some cases, only one description will be necessary for a group of pictures, because the group of pictures may be pictures of a single product for which only description is necessary.

The description entrance template 38 contains data entry fields 18, allowing the consumer to enter information such as type of product, price, size, quantity, model, color, etc., and may include a description field to allow the consumer to type a brief qualitative description of the product. The web page may prompt the consumer to select between a custom description entrance by pressing button 44 or a template-based description entrance by pressing button 46. In the template-based description entrance, the consumer may simply enter the information as it is solicited in the description entrance template 38. In the custom description entrance, the consumer may choose how to present the information. For example, clicking on the custom description entrance button 44 may allow the consumer to upload HTML code, containing instructions for displaying a graphic and attractive display of information about the product shown in the picture display 36. The consumer may enter a description of each different picture by clicking on the relevant picture in the thumbnail selection screen 40. Alternatively, the template shown in FIG. 4 may be avoided altogether and the user may upload HTML or XML code (or other code) for the entire web page. In such an embodiment, the user uses only the company's primary address (along with the secondary address assigned to the user) and, possibly, the web space provided by the company, and the webpage itself is designed completely by the user and uploaded as preferably HTML code to the company's web server.

The consumer may also choose from among several accessories in the accessories selection screen 48. One accessory may be a counter, as known in the art, allowing the consumer to track the total number of visits to her web page, after being created. Another accessory may be a Bid Box, allowing potential purchasers of the product to submit bid information to the selling consumer. This submitted bid information may then be shown on the consumer's unique web page and/or sent directly to the consumer via email or other contact information. The company's website and processor may be configured to alert the consumer if the total cost of the selected package plus any selected accessories exceeds the cost of the next available package, so that the consumer may choose the next available package (which has at least the same features and accessories as those previously chosen by the consumer) for a lower price.

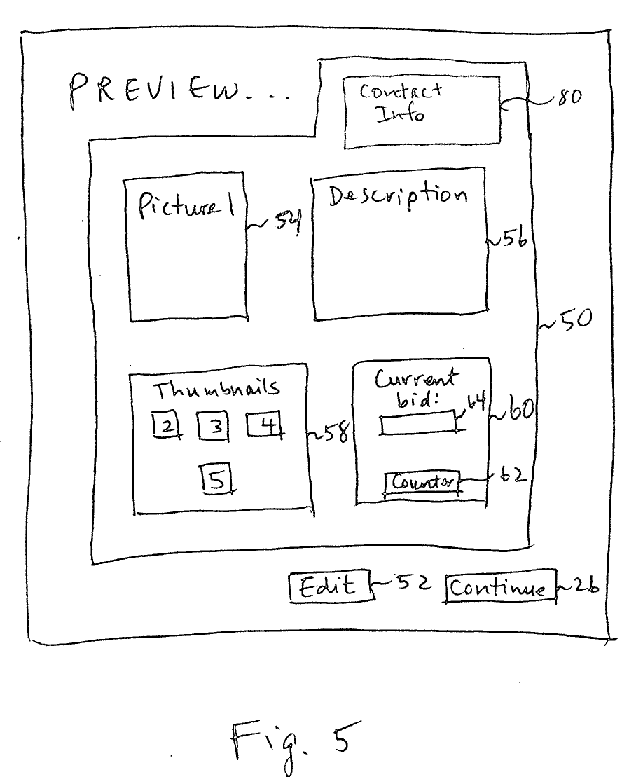

In the web page shown in FIG. 5, the consumer may preview the consumer's ad, as it would appear to potential purchasers after the ad is posted on the website. The web page shown in FIG. 5 may have a format similar to that shown in the template shown in FIG. 4, such as a picture display 54, a description screen 56, a thumbnail selection screen 58, an accessories screen 60, and preferably a contact information screen 80. The description screen 56 may display information about the product shown in the picture display 54, preferably in the manner chosen by the user in the template shown in FIG. 4 (e.g., in an attractive HTML format if HTML code was entered in the template of FIG. 4 by pressing the custom description entrance button 44). An enlarged picture of each of the thumbnails in the thumbnail selection screen 58, as well as a description of the corresponding product, may be shown in the picture display 54 and description screen 56 by clicking on the corresponding thumbnail in the thumbnail selection screen 58. The accessories screen 60 may include information or data entry fields as desired and selected in the accessories selection screen 48 in FIG. 4. For example, the accessories screen 60 may include a box 64 to display the current bid (as well as another Bid Box, not shown, to allow a potential purchaser to enter a higher bid) and a counter 62 to display the number of “hits” to the consumer's web page. (These accessories may expire upon expiration of the consumer's webpage, pursuant to the package purchased by the consumer.) The contact information screen 80 may contain contact information of the seller, such as name, email address, and/or phone number, so that an interested potential purchaser can contact the seller. The preview web page shown in FIG. 5 may include an edit button 52 to allow the consumer to edit information shown in the preview.

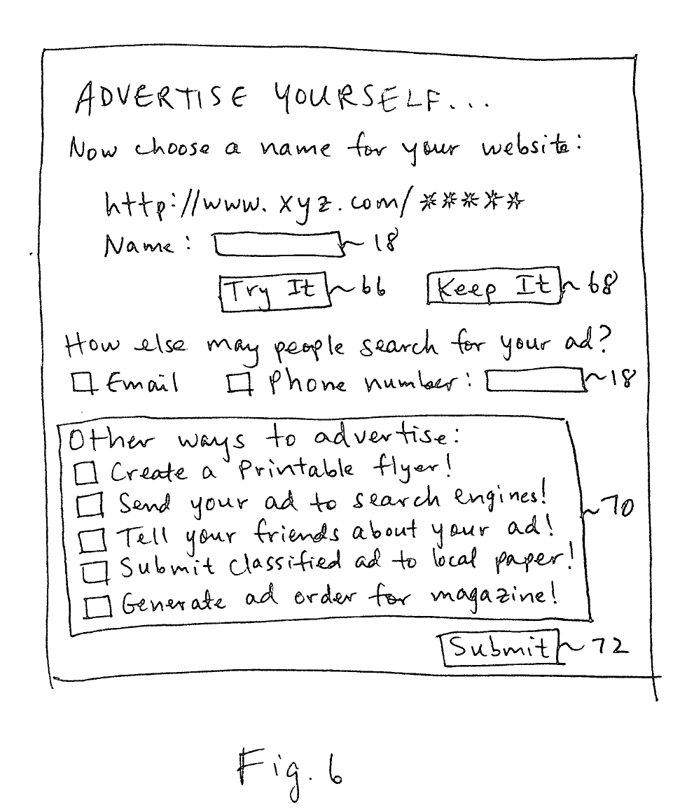

FIG. 6 furthers the template introduced in FIG. 2. In the web page shown in FIG. 6, the consumer may select, via data entry field 18, a secondary web address that the consumer's web page will be associated or linked to. For example, if the consumer, James of Dallas, Tex., in the template shown in FIG. 4, uploaded pictures and information about his Nissan car for sale, he may choose “JamesCar” as his secondary address. He may then click the “try it” button 66. Then, the entry in the data entry field 18 may be uploaded to the company's server, and may be compared to other secondary addresses currently existing. If the consumer's secondary address choice is not available, the consumer may be immediately notified and prompted to enter a different secondary address. (Whether a secondary address is available may depend on either a local or a global secondary address pool. For example, www.xyz.com/JamesCar may not be available, but perhaps the Jacksonville, Fla. website jax.xyz.com/JamesCar is available.) Alternatively, in one preferred embodiment, a processor (not shown) connected to the company's server may select a secondary address based on the consumer's personal or product information, and may prompt the consumer to accept or reject the selection. For example, if “JamesCar” is not available (e.g., if “JamesCar” is a secondary address already associated with a different web page), the company's computer may then select “JamesCar1” or “JamesNissan” or “DallasJames,” or the like, and notify the consumer via the template shown in FIG. 6. The company's processor may select several such available secondary addresses and provide this list to the consumer in the form of a drop-down menu. Alternatively, the company's processor may be configured to allow the consumer to try at least three different secondary addresses, before it automatically creates a drop-down menu of available secondary address suggestions. After the consumer has found an available secondary address that he is happy with (whether by trying several possible secondary addresses or by acquiescing to a secondary address generated by the company's computer), he may click the “keep it” button 68, in which case the kept secondary address is reserved in the client's server. Once created, the consumer's unique web page (containing pictures and information about the product(s) for sale by the consumer, e.g., as previewed in the web page shown in FIG. 5) will be accessible on the WWW by typing the company's primary web address, as well as the consumer's secondary web address, into the address box of a web browser. For example, if James (the consumer) decided to keep “JamesNissan” as his secondary web address, his unique web page would be accessible via the web address, www.xyz.com/JamesNissan. If James preferred to advertise his Nissan car only in the Dallas portion of the company's website, his unique web page may instead be accessible via the consumer's unique web address, dallas.xyz.com/JamesNissan. These examples are offered for explanation only. One skilled in the art will recognize that there are many possible embodiments of primary and secondary web address selection and usage that fall within the scope of the present invention.

In another preferred embodiment, the secondary web address contains no more than 15, and preferably no more than 10, characters. This is because the consumer's unique web address is easier to advertise the shorter the address is. For example, www.xyz.com/car (whose secondary address has only three characters) is cheaper to advertise, and more easily remembered by potential purchasers, than a longer address, such as www.xyz.com/NissanSentraCarOfJamesInDallas (whose secondary address has 30 characters). Of course, the secondary address need not consist of alpha characters. For example, the consumer may choose her phone number as the secondary address, which serves the double purpose of providing a unique, simple web address and a reference to the consumer's phone number (or the company's computer may choose the consumer's phone number and offer this to the consumer for acceptance or rejection in the template shown in FIG. 6).

Next, the template in FIG. 6 may prompt the consumer to identify ways in which the ad may be searched (e.g., via the search engine interface 16) by potential purchasers, such as by email, phone number, etc.

In a preferred embodiment, the company's website should encourage the consumer to advertise the consumer's unique web address in other media, preferably non-electronic media, such as newspaper classified ads, magazine ads, flyers, word of mouth, emails, etc. Shown in the web page of FIG. 6 is an advertising means template 70 in which the consumer may choose from several means to advertise either the product for sale, the electronic ad for the product (as created by the present method), or both. For example, the advertising means template 70 may include a button or selection to allow the consumer to automatically create a printable flyer based on the product information entered. In such an embodiment, the company's computer may automatically format the entered product information into the form of an attractive, easily readable flyer that the consumer may subsequently download, print, and post in conspicuous places (such as the consumer's work, school, church, or the like). The created flyer may include only a single picture of the product for sale and a brief description of the product, or may contain more than one picture. The option may be a “one-click” option in which the flyer is created and printed with a single click of the mouse.

The advertising means template 70 may include a button or selection to allow the consumer to automatically send a link (to the consumer's unique web page) to web-based search engines, such as Google or Excite, as understood by those skilled in the art.

The advertising means template 70 may include a button or selection to allow the consumer to automatically send a link to the consumer's unique web page to friends, family, or coworkers via email. For example, after selecting this option, the consumer may be prompted to enter a brief message and the email addresses of her friends, family, and/or coworkers. The company's computer may then generate a simple email message, including the client's unique web address (e.g., dallas.xyz.com/JamesNissan) and/or a link to the consumer's unique web page, and may automatically email this message to those email addresses entered by the consumer.

The advertising means template 70 may include a button or selection to allow the consumer to automatically submit a classified advertisement to a local newspaper. For example, if the consumer selects this option, the company's computer may search a database (within the company's computer) of newspapers that may be local to the consumer. For the example previously given (James of Dallas), the company's computer may determine one or more newspapers that are located in Dallas. (If there is more than one newspaper in the consumer's locale, the advertising means template 70 may include a list of newspapers that the consumer may choose from. If such a newspaper allows electronic submissions to the classified ad department, the company's computer may then automatically generate a classified ad that includes the consumer's unique web address, and may electronically submit it to the newspaper. For example, the computer may generate an ad stating “2001 Nissan Sentra. View dallas.xyz.com/JamesNissan for details,” and may submit this ad to the “Nissan automobiles” section of the newspaper's classified ads. If the newspaper does not allow electronic submissions, the company's computer may automatically generate a paper classified ad request form which may be sent to the newspaper classified department by an employee of the company.

Further, the advertising means template 70 may include a button or selection to allow the consumer to automatically generate a paper advertisement request form for submission to a newspaper, magazine, or other media. For example, if the consumer selects this option, the company's computer may prompt the consumer to enter a magazine title. Then, based on a database stored in the company's server, the company's computer may extract an advertisement submission address of the magazine, generate an ad (such as the one mentioned above), and create an advertisement request form including the submission address. The consumer may then print this request out and send it to the submission address, with appropriate fee.

After the information in the template shown in FIG. 6 is entered, the consumer may click a submit button 72, in which event the information entered is uploaded to the client's server for processing. At this point, the electronic ad may be generated in the form of a consumer's unique web page, and the consumer's selected unique web address may be assigned to this unique web page, so that the consumer's unique web page may be accessed and viewed by typing the consumer's unique web address into the address field of a web browser.

The company may, of course, charge a fee for any and all of the above mentioned packages and/or options. For example, the company may pass the cost of placing the newspaper classified ad to the consumer, possibly with an additional processing fee. The template as shown in FIGS. 2-6 may also include a template with data entry fields into which the consumer may enter payment information, such as credit card information and billing address. One or more of the packages may be offered for free, in order to encourage consumers to use the company's package products and to build a customer base.

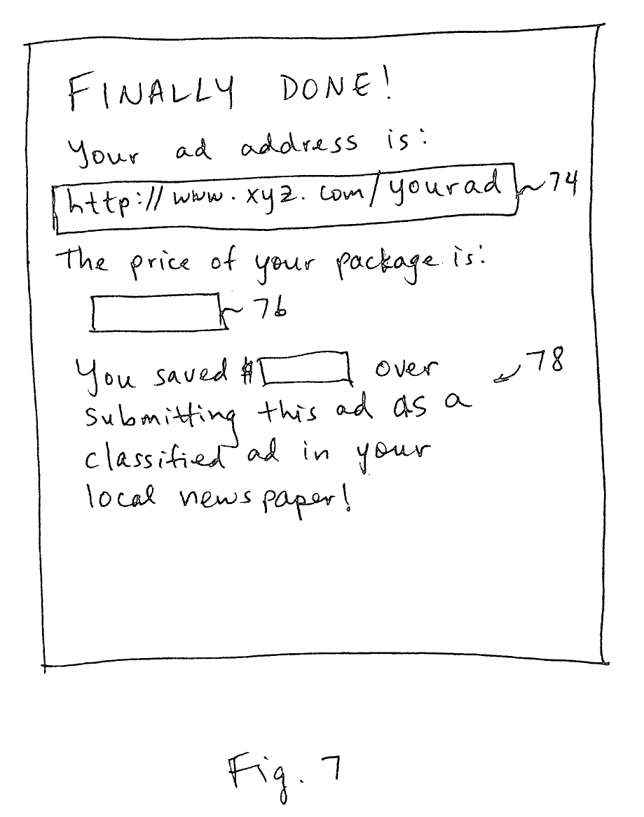

FIG. 7 shows a web page showing the consumer's unique web address in field 74. The page may also include a comparison 76, 78 which compares the total price 76 of the package with a savings 78 of submitting a comparable ad as a classified ad in a local newspaper. In other words, because information storage space (via the company's web server or hard drive) is so inexpensive compared to advertising rates, it is very advantageous to reduce the total length of a classified or other advertisement, and to place this removed information onto a web server. Thus, as in the preceding example, if James' description of his Nissan car includes 50 words and a picture, the price for submitting a 50-word classified advertisement to a newspaper (without picture, of course) may be $100. However, if James instead uses the company's services, he may pay $20 for package B and an additional $10 for automatically submitting the shortened classified ad (“2001 Nissan Sentra. View dallas.xyz.com/JamesNissan for details.”) to the newspaper, for a total of $30. The total package price of $30 may be displayed at price 76, and the total savings of ($100−$30=) $70 may be displayed in savings 78. The savings information 78 can, of course, be based on published advertising rates of the newspaper, which may be stored in a database in the client's server.

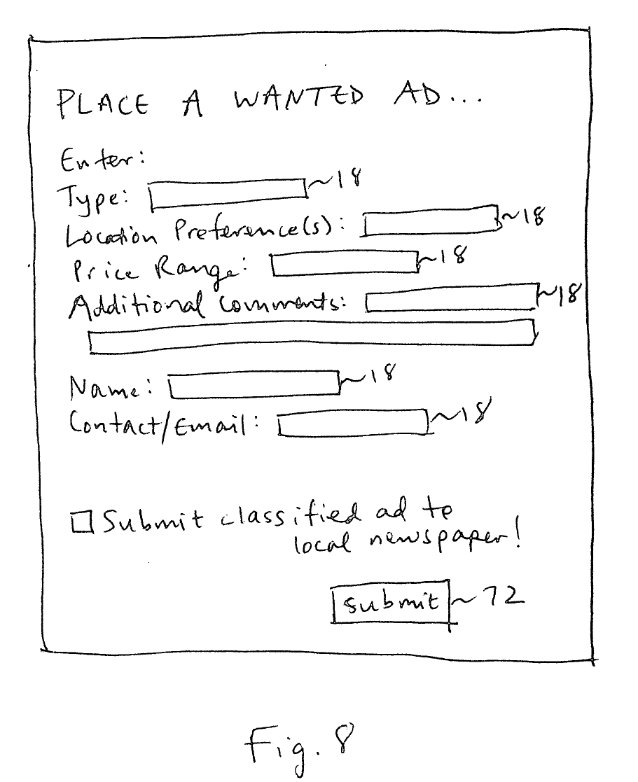

FIG. 8 shows a web page according to another embodiment of the present invention. The web page shown may serve as a template for potential purchasers to enter information about a product that is wanted for purchase. The web page may prompt the potential purchaser to enter information about the product desired, such as type, location preference, price range preferred, size, shape, quantity, color, model, etc. The web page may also prompt the potential purchaser to enter personal contact information, such as a name and email address. If a consumer later submits (or has already submitted) information about a product matching the criteria selected by the potential purchaser, the potential purchaser may automatically be contacted, and/or sent an email containing a link to the unique web page of the consumer advertising the desired product. The potential purchaser may also have the option, possibly with a fee, of submitting the wanted ad to a local newspaper. A wanted ad for a Toyota car may read, e.g., “Toyota wanted. Submit information at seattle.xyz.com.” After a consumer, who would like to sell his Toyota to the potential purchaser, has formed a unique web page according to the embodiments shown in FIGS. 1-7, the potential purchaser may be contacted by email with the consumer's unique web address.

The present invention is not limited to the discussed embodiments. Other embodiments and features, such as the ones described below, are within the scope of the present invention.

Stats Section. The “My Account” section will include a statistics or “stats” page (most likely for small business customers). Stats page can include data like web page hits, times, and where the viewer came from last, and other stats.

Save Now Section. This section will be on the “finally done” or payment page (e.g., FIG. 7) and will allow the customer to save money by including local advertising on his web page. For example, a customer would like to sell his car and his digital ad price will cost $5.75. The customer could save $0.50 by placing a banner ad for a local car dealer (or other advertisement) on his own digital ad. The banner will be automatically placed on his digital ad.

Link Exchange. A customer will pay an extra fee to have a banner for his digital ad (auto-generated) placed on somebody else's digital ad. This must be a mutual agreement. The other customer must have signed up for the ‘program’ as well. The banner would be strategically placed on a random digital ad that subscribes to the link exchange service. For example, Jack will pay an extra $0.25 to have his banner (for his digital ad) placed on Jill's digital ad. Jill in turn (for $0.25) will have her digital ad placed on Jack's page or another user's ad who has signed up for Link Exchange. These users all have one thing in common. For example, they may all be selling sofas (in Jacksonville).

“No Description” Button. Will automatically ‘gray out’ description box 38, when a description is not needed. For example, one television with two views, front and side, does not need two descriptions.

Auto Banner Creation. An advertising instrument listed under the “Advertise Yourself” section (e.g., FIG. 6). Auto Banner Creation creates a banner for your digital ad that you can place on your own website or other websites. There can be an additional charge for this or any other feature disclosed herein.

In place or in addition to digital pictures uploaded in the “Upload Center” (e.g., FIG. 4), digital video (which may include sound) can be uploaded. It can also be any animated presentation that the customer wishes, e.g., a Microsoft Powerpoint presentation.

Featured Items. Featured items provide increased visibility at an added cost. The advertising section will allow the customer to ‘Feature’ his digital ad in several ways:
a. When a potential purchaser browses for a specific item in a specific city, a featured item will be displayed on a banner at the top of the search results page.
b. When a potential purchaser browses for a specific item in a specific city, a featured item will be displayed in the featured items section at the top of the results page. It will be the first of the results displayed, perhaps always.
c. When a potential purchaser accesses the local homepage of a particular city (more below) the featured item may show up in a banner ad or featured finds section.

HTML Based Page. Instead or in addition to the templates offered in the “Upload Center” (e.g., FIG. 4), the user may create his own page in HTML and use the URL service of the company, or may create his own page in HTML, and use the templates and URL service of the company. In such an example, the customer simply uses the website as an advertising launch pad.

Name Expiration. The secondary address may expire after the page expires. Customer may have an option to buy rights to use the secondary address for an extended period of time.

Location Assignment. When a customer registers on www.xyz.com, his address, zip code, etc., may be checked against a database. The customer will then be assigned to the appropriate local home page. For example, a customer signs up to with the zip code of 32608. His zip code is checked against the database and matched to Gainesville, Fla. A cookie is placed on his computer and every time he accesses www.xyz.com, he is redirected to gnv.xyz.com, for example. When he logs in to the website, the same process takes place. All digital ads he creates use the primary address of gnv.xyz.com and his own secondary address. Alternatively, when the customer performs a search to find an item, he will be prompted for a zip code and be brought to the local website first, then perform the search. In another scenario, the user can type in the zip code or city and state and item and be brought directly to the search results.

Local Home Page. Every registered user will be assigned a local home page that serves as an advertising platform for the local population. Featured digital ads will be displayed in a ‘Featured Finds’ section. A ‘Local Links’ section will be available to advertise garage sales, yard sales, local auctions, and other events. These events do not have to be displayed in the form of a digital ad but should have something to do with local shopping. A ‘Local Links’ ad will have an associated URL but may have the same format as a regular digital ad. There may also be a different pricing scale.

Location Assistance. This seller tool will allow the purchaser, when contacted by the buyer, to send a link where the buyer may input his address and get directions to the seller's household or place of business. For security purposes, the seller should send the link. The link can include other indicative information, such as name, telephone number and address.

No-Ship Auction. Sellers can drop off items at a local warehouse. Buyers can pick these items up and pay. Sellers are remitted the sale amount, with a percentage deducted for fees. This enables buyers and sellers to perform transactions without shipping costs and time limitations.

In another embodiment of the present invention, instead of actually hosting an internet web page for a customer (for example, instead of hosting an online marketplace or auction website), the customer may have his own web page hosted by another provider. An existing electronic address may be assigned to that web page such that the web page may be viewable when the existing electronic address is accessed. However, the existing electronic address may be very long (in number or characters) and/or complicated (such as containing many non-letter characters, such as slashes (/), question marks (?), periods (.), and so forth) and/or not very memorable (such as a collection of letters or numbers or punctuation in no particular order (e.g., “gn5Hne33j”). For example, users of eBay.com, Amazon.com, and other common online selling/auction sites may find that the existing electronic address assigned to their web pages are very long and virtually impossible to advertise in non-internet media, such as newspapers, magazines, radio, television, and so on. For example, an existing electronic address for a cellular phone for sale on an eBay.com auction may look like this:

http://cgi.ebay.com/ws/eBayISAPI.dll?ViewItem&item=9711581908&rd=1&sspagename=STRK%3AMESO%3AIT&rd=1

(The above electronic address includes 92 characters, exclusive of the “http://” which is understood in most modern electronic addresses.) Of course, this electronic address contains many characters and is very complicated and not at all memorable. Therefore, in one embodiment, instead of or in addition to actually hosting a web page for the customer, a user of the present invention may create and provide a customer with an electronic address that is substantially shorter than the existing electronic address and/or more easily memorable and/or chosen at least in part by the customer, and then assign that electronic address to the internet web page so that the internet web page is viewable when the electronic address is accessed. Thus, in the above example, the electronic address www.xyz.com/cellphone (which has a total of 21 characters) may be created and provided to the customer and assigned to the same internet web page that the above-mentioned existing electronic address is assigned to, so that someone accessing www.xyz.com/cellphone will be able to view the same web page. Any method of assigning the (new, shorter, simpler, more memorable) electronic address to the internet web page is within the scope of the present invention, including a simple redirect of the new electronic address to the existing electronic address, whereby the new electronic address would be assigned to the internet web page via the existing electronic address. Specifically, the existing electronic address may contain substantially more characters than the new electronic address, and/or may contain at least approximately 25 characters, and/or at least approximately 30 characters, and/or at least approximately 40 characters, and/or at least approximately 50 characters.

In operation, the customer may enter his existing electronic address into an input box in a website of the user of the present invention, and then the website (or user) may choose a new (shorter, easier, more memorable) electronic address and redirect that electronic address to the existing electronic address. The new electronic address (such as the secondary address portion of the electronic address) may be chosen in whole or in part by the customer. Alternatively or in addition, the user's website may be compatible and/or may cooperate with a website or web server corresponding to the customer's existing electronic address such that the input box is automatically populated or filled with the customer's existing electronic address (or an input box may not be shown at all to the customer). For example, assume that eBay.com cooperated with the user's website. When a customer creates a web page (e.g., corresponding to an auction of the customer), eBay.com generates a very long, complicated, nonmemorable existing electronic address. The customer may then be queried as to whether he would like to advertise the auction web page in a non-internet medium. If so, when the customer clicks the appropriate “link,” he is directed the user's website, wherein the complicated existing electronic address is automatically received or extracted by the user's website, and the user's website may then proceed as normal by creating a shorter, easier, more memorable electronic address and associating that electronic address with the customer's web page. The above-mentioned input box may or may not exist, and particularly may not exist in the embodiment in which the existing electronic address is automatically received by the user's website. Alternatively or in addition, eBay.com (or other online store, marketplace, or auction site example) may instead itself utilize the method of the present invention by offering the customer the option of simplifying the complicated existing electronic address into a new, simpler, more memorable address, and then encouraging the user to advertise the electronic address in non-internet media and/or offering to automatically advertise the electronic address in non-internet media. Whether or not the online store, marketplace, or auction site is the user of the present invention, the user or the user's website may proceed as previously described, such as to encourage the customer to advertise the new electronic address in non-internet media, such as newspapers, magazines, radio, television, etc., and/or may automatically submit an advertisement containing the electronic address to a non-internet medium on behalf of the customer.

In another embodiment, the present invention includes tracking a number of times the electronic address is accessed. For example, if in the above example www.xyz.com/cellphone is an electronic address that redirects to the very long, complicated aforementioned existing electronic address (thus allowing viewing of the internet web page by accessing www.xyz.com/cellphone), then the present invention includes tracking a number of times that the electronic address www.xyz.com/cellphone is accessed. This number of times may be based on a number of independent hits (e.g., from different Internet Protocol (IP) addresses or locations), and/or based on number of hits independently of IP addresses or locations. Further, this information may be provided to the customer for free or for a fee, to allow the customer to determine an effectiveness of the non-internet medium advertisement in which she has advertised the new electronic address. For example, if she has advertised the electronic address in a non-internet medium at a cost of $500, and the ad generated 500 hits from different IP addresses, then she can determine that the cost to her was $1 per hit. Further, the present invention may include determining an effectiveness (such as number of accesses to the electronic address (or “hits”), percentage of users who make a purchase after accessing the electronic address, profits generated by the non-internet advertisement as a function of cost, and so forth) of a non-internet advertisement containing the electronic address. Further, the present invention may include capturing other statistical information, such as geographical information of customers (such as based on IP address information), demographic information of customers, computer information of customers (e.g., operating system, browser type or brand, type of internet connection, number of computers connected to local area network, etc.). The above information may be provided to the customer free or for a fee, such as a cost per type of information or a cost per entire information portfolio.

Further, the present invention includes charging a customer a fee or advertising price based at least on a number of times the electronic address is accessed. For example, a user of the present invention may purchase advertising space in a non-internet medium, such as a magazine or newspaper or newpaper classifieds section or radio air space or television air space, etc. Then, the user may sell a portion of the space to a customer whereby the customer's advertisement in the portion of the space includes the customer's electronic address, so that patrons of the customer may view the customer's internet web page by accessing the electronic address. The customer may pay a flat fee to the user for this portion of the space, or may pay on a “pay-per-click” or “pay-per-hit” basis, whereby the customer pays the user in whole or in part as a function of the number of patrons who access the customer's advertised electronic address. For example, the customer may agree to pay the user $2 per hit to the advertised electronic address. Alternatively or in addition, the customer may agree to pay the user $5 per sale that directly results from a patron's hit to the advertised electronic address. Alternatively or in addition, the customer may agree to pay a total fee consisting in part of a flat fee and in part a pay-per-hit fee and/or pay-per-sale fee (based on hits generated by the advertisement). In another embodiment, the price that the user charges per click or hit (or per sale based on hits) on the customer's electronic address may be determined at least in part by an auction. For example, five customers may compete via an auction for the price-per-hit paid to the user for advertising space in the non-internet medium (as arranged by the user). If only two advertising spaces are available, then the customers who bid the highest in pay-per-hit may be awarded the advertising spaces. In the above examples, the non-internet advertising medium may itself implement the present invention, thus being the user of the present invention. (In other words, the advertising medium itself may allow customers to advertise their short, memorable electronic addresses (which the advertising medium may or may not have created and associated with the customers' web page), and then charge the customers on a pay-per-hit basis or any other basis mentioned herein.)

In another embodiment, a customer's advertisement including the customer's new electronic address may also include the customer's phone number (and/or a phone number assigned to or forwarding to the customer's existing phone number by the user) and any and all of the above features (such as tracking or number of hits and/or geographic and/or demographic information, pay-per-call, pay-per-sale (based on calls to the assigned phone number), etc.) may be included. Further, where the new (simpler) electronic address assigned to the customer's web page includes a designation of the customer's phone number (and/or a phone number assigned to the customer by the user), the user may gather information about calls made to the phone number and/or hits to the electronic address, and provide information (as described previously) to the customer and/or charge the customer based on the calls and/or hits. For example, if the customer's new electronic address (assigned to his web page via the existing electronic address) is www.xyz.com/8001234567, then a patron of the customer may view the customer's web page by accessing the aforementioned electronic address, and/or may contact the customer by calling 800-123-4567. In both cases, assuming that the 800 number was assigned to the customer by the user (which number may then forward to the customer's existing phone number), then information (such as number of calls and/or web hits and/or any other statistical information that may be collected) may be gleaned by the user and provided to the customer for a fee, and/or the customer may be charged on a flat fee basis, pay-per-hit basis, pay-per-call basis, pay-per-sale basis (based at least in part on the number of hits and/or calls), or any combination of these.

In another embodiment, a print medium, such as a newspaper classifieds section, may have a section devoted entirely to ads placed by customers of the user. For example, the classifieds section may be labeled “Visit www.xyz.com/_ for more information,” and each ad may begin with only the secondary address and may include a short description, price, or contact information thereafter. For example, a classified ad in this section may read “couch3—Antique couch for sale, $250.” Then, a reader of the classifieds section may simply type in the electronic address www.xyz.com/couch3 into his internet browser application to view the web page corresponding to the antique couch for sale. Alternatively, the secondary address could be a local phone number, as previously discussed.

In another embodiment, the method may include encouraging customers to advertise their new, shorter, more memorable electronic addresses in locations in the print and/or non-internet media in which they will have the most effect, such as “relevance” ads, whereby a normal news article is appended and/or surrounded by advertisements that are relevant to the article's subject matter. For example, in an article about automobiles, a relevance ad may follow, precede, surround, or be located within the article, and the ad may (for example) advertise an automobile for sale. The advertisement may then include the memorable electronic address, which when accessed allows a patron to view the associated web page. Of course, any of the above mentioned tracking of hits or statistical information may be utilized in any manner previously suggested. The memorable electronic address may be created and assigned by a user of the present invention, which may or may not be the non-internet advertising medium itself.

Most of the embodiments described herein have represented simple versions for clarity of explanation. As understood by one of ordinary skill in the art, many of the features and/or aspects of the embodiments described herein may be “mixed and matched” to the extent possible to satisfy individual design requirements.

What we claim is:

1. A method of advertising, comprising:
a) creating and providing a customer with an electronic address;
b) assigning the electronic address to an internet web page so that the internet web page is viewable when the electronic address is accessed;
c) encouraging the customer to advertise the electronic address in a non-internet medium; and
d) enabling the customer to automatically advertise the electronic address in a non-internet medium by submitting an advertisement containing the electronic address to the non-internet medium on behalf of the customer,
wherein the electronic address comprises a primary address and a secondary address, the primary address assigned to a main web page and the secondary address having at least one of the following properties: the secondary address is chosen at least in part by the customer; and the secondary address contains no more than approximately fifteen characters.

2. The method as claimed in claim 1, wherein the secondary address is chosen at least in part by the customer.

3. The method as claimed in claim 1, wherein the secondary address contains no more than approximately fifteen characters.

4. The method as claimed in claim 1, wherein the secondary address contains no more than ten characters.

5. The method as claimed in claim 1, wherein step c) comprises encouraging the customer to advertise the electronic address in at least one of a newspaper advertisement and a magazine advertisement.

6. The method as claimed in claim 1, wherein the primary address includes a designation of a geographical region, wherein the geographical region includes one of a city and a state.

7. The method as claimed in claim 1, further comprising enabling the customer to track a number of visits to the internet web page.

8. The method as claimed in claim 1, further comprising enabling the customer to track statistical information about patrons who access the electronic address.

9. The method as claimed in claim 1, wherein the internet web page was viewable by accessing an existing electronic address before performing step a), the existing electronic address containing substantially more characters than said electronic address.

10. The method as claimed in claim 9, wherein the existing electronic address contains at least approximately 30 characters.

11. The method as claimed in claim 10, further comprising enabling the customer to track a number of visits to the internet web page.

12. The method as claimed in claim 1, further comprising tracking a number of times the electronic address is accessed.

13. The method as claimed in claim 12, further comprising charging the customer a fee based at least in part on the number of times the electronic address is accessed.

14. The method as claimed in claim 12, further comprising charging the customer a fee based at least in part on a number of sales generated by accessing the electronic address.

15. A method of advertising, comprising:
a) creating and providing a customer with an electronic address;
b) assigning the electronic address to an internet web page so that the internet web page is viewable when the electronic address is accessed;
c) encouraging the customer to advertise the electronic address in a non-internet medium;
d) enabling the customer to automatically advertise the electronic address in a non-internet medium by submitting an advertisement containing the electronic address to the non-internet medium on behalf of the customer; and
e) enabling the customer to track a number of visits to the internet web page,
wherein the electronic address comprises a primary address and a secondary address, the primary address assigned to a main web page and the secondary address chosen at least in part by the customer.

16. The method as claimed in claim 15, wherein the secondary address contains no more than approximately fifteen characters.

17. The method as claimed in claim 16, wherein the internet web page was viewable by accessing an existing electronic address before performing step a), the existing electronic address containing at least approximately 30 characters.

18. The method as claimed in claim 17, further comprising tracking a number of times the electronic address is accessed and charging the customer a fee based at least in part on the number of times the electronic address is accessed.

19. The method as claimed in claim 15, wherein the internet web page was viewable by accessing an existing electronic address before performing step a), the existing electronic address comprising at least approximately 30 characters.

20. The method as claimed in claim 15, further comprising tracking a number of times the electronic address is accessed and charging the customer a fee based at least in part on the number of times the electronic address is accessed.
